(19) United States
(12) Patent Application Publication
(10) Pub. No.: US 2024/0034211 A1
(43) Pub. Date: Feb. 1, 2024

(54) HEAD RESTRAINT FOR A VEHICLE SEAT

(71) Applicant: JAGUAR LAND ROVER LIMITED, Whitley (GB)

(72) Inventor: James SUFFOLK, Whitley (GB)

(21) Appl. No.: 18/358,736

(22) Filed: Jul. 25, 2023

(30) Foreign Application Priority Data
Jul. 26, 2022 (GB) GB2210909.4

(51) Int. Cl. B60N 2/856; B60N 2/818; B60N 2/844

(52) U.S. Cl. CPC B60N 2/856; B60N 2/818; B60N 2/844

(57) ABSTRACT

A head restraint for a vehicle seat having a seatback includes a head support and a head restraint mounting assembly for mounting the head restraint to the seatback. The head restraint mounting assembly has a first mounting stem. The head support is pivotably mounted to the head restraint mounting assembly. An actuating cable is configured to control pivoting of the head support about a pivot axis.

### CROSS REFERENCE TO RELATED APPLICATION

The present application claims priority to Great Britain Patent Application No. 2210909.4 filed on Jul. 26, 2022. The entire contents of the above-listed application are hereby incorporated by reference for all purposes.

### TECHNICAL FIELD

The present disclosure relates to a head restraint for a vehicle seat. Aspects of the invention relate to a head restraint, a seat assembly and a vehicle.

### BACKGROUND

It is known to provide vehicle seats with a head restraint that may be pivoted downwardly when not in use, for example to provide improved visibility for the driver through a rear window of the vehicle. The pivoting movement of the head restraint may also be used to facilitate stowage of the vehicle seat when not in use or to increase the space in a load bay of the vehicle. These types of head restraint may, for example, be incorporated into a vehicle seat in a second row or a third row of the vehicle. The head restraint must still comply with safety requirements for head restraints. In particular, the head restraint must satisfy test requirements at different heights and orientations. The deployment of the head restraint may require completion of several discrete operations, potentially in a predetermined sequence. The need to complete several operations results in additional complication.

It is an aim of the present invention to address one or more of the disadvantages associated with the prior art.

### SUMMARY OF THE INVENTION

Aspects and embodiments of the invention provide a head restraint, a seat assembly and a vehicle as claimed in the appended claims.

According to an aspect of the present invention there is provided a head restraint for a vehicle seat having a seatback, the head restraint comprising:
a head support;
a head restraint mounting assembly for mounting the head restraint to the seatback, the head restraint mounting assembly comprising a first mounting stem, wherein the head support is pivotably mounted to the head restraint mounting assembly; and
an actuating cable configured to control pivoting of the head support about a pivot axis. At least in certain embodiments, the actuating cable may facilitate pivoting of the head support, for example to a usable position and/or an unusable position. The actuating cable may provide automated or semi-automated control of the pivoting of the head support. The actuating cable may, for example, cause the head support to pivot about the pivot axis as the head support is raised or lowered.

The head support may be pivotable between a first pivot position and a second pivot position. The head support may be pivotable between a usable (deployed) pivot position and an unusable (undeployed) pivot position. The actuating cable may be operable to displace the head support towards or into the usable position. Alternatively, the actuating cable may be operable to displace the head support towards or into the unusable position.

The first mounting stem may comprise a first tubular member. The head restraint mounting assembly may comprise a second mounting stem. The second mounting stem may comprise a second tubular member.

In use, the head support is pivotable relative to the head restraint mounting assembly. The actuating cable may apply a pulling force to pivot the head support about the pivot axis in a first direction.

In a variant, the head restraint may comprise first and second actuating cables. The first actuating cable may apply a first force to pivot the head support about the pivot axis in a first direction. The second actuating cable may apply a second force to pivot the head support about the pivot axis in a second direction. The first and second directions may be opposite to each other. The first and second actuating cables may be connected on opposite sides of the pivot axis. The first actuating cable may be connected above the pivot axis and the second actuating cable may be connected below the pivot axis. The first and second actuating cables may provide a closed loop mechanism.

The actuating cable may be maintained under tension. A tensioning member be provided to maintain the actuating cable under tension. A resilient member, such as a spring, may be incorporated into the actuating cable or an associated tensioning assembly.

The actuating cable may be fastened to the head support at a first anchor point which is offset vertically from the pivot axis. The first anchor point may be disposed above the pivot axis (towards a top of the head support). In a variant, the first anchor point may be disposed below the pivot axis (towards a bottom of the head support).

The mounting assembly may comprise a crossmember. The crossmember may define the pivot axis. The head support may be pivotably mounted to the crossmember.

The crossmember may extend in a transverse direction. The crossmember may extend substantially perpendicular to the first mounting stem. The crossmember may be mounted in one or more bearings. The one or more bearings may be supported by one or more brackets disposed on the head support.

The crossmember may comprise a tubular member. The crossmember may comprise a central longitudinal axis which is coincident with the pivot axis.

The head restraint mounting assembly may comprise a second mounting stem. The first and second mounting stems may extend substantially parallel to each other. The first and second mounting stems may be configured to locate in mounting tubes disposed in a seat back. A height adjustment mechanism may be provided to adjust the height of the first and second mounting stems relative to the seatback.

The first and second mounting stems and the crossmember may be arranged in a generally U-shaped arrangement.

The head restraint may comprise a spring member for biasing the head support in a first pivot direction or a second pivot direction. The spring member may be configured to bias the head support towards the unusable position. A positive action may be required to overcome the spring member to displace the head support to the usable unless. The spring member may help prevent the head support being displaced inadvertently to the usable position. Alternatively, the spring member may be configured to bias the head support towards the usable position.

The spring member may operate in opposition to the actuating cable. The force applied by the actuating cable may oppose the spring bias applied by the spring member.

The spring member comprises a torsion spring, for example disposed around the crossmember.

The actuating cable may be disposed at least partially inside the first mounting stem. This may reduce or prevent interference of the actuating cable with external features. The first mounting stem may comprise a tubular member. The actuating cable may extend along at least some of the length of the first mounting stem. The actuating cable may be introduced into the first mounting stem at a first end. The actuating cable may exit the first mounting stem at a second end. Alternatively, an inlet aperture and/or an outlet aperture may be formed in the first mounting stem. The inlet aperture may be spaced apart from the first end of the first mounting stem. The outlet aperture may be spaced apart from the second end of the first mounting stem.

The head restraint may comprise a pivot locking mechanism operable to inhibit or restrict pivoting movement of the head support about the pivot axis. The pivot locking mechanism may be operable to inhibit or restrict pivoting movement of the head support relative to the head restraint mounting assembly. The pivot locking mechanism may be operable to lock the head support in a predetermined orientation relative to the head restraint mounting assembly. The predetermined orientation may correspond to the usable or the unusable position of the head support. The pivot locking mechanism may prevent the head support being displaced away from the predetermined orientation relative to the head restraint mounting assembly. A release mechanism may be provided for releasing the pivot locking mechanism. The release mechanism may be operated manually. Alternatively, or in addition, the release mechanism may be at least partially automated. For example, the release mechanism may comprise an actuator, such as a solenoid or a motor, for releasing the pivot locking mechanism. The release mechanism may comprise an actuator for releasing the pivot locking mechanism. The release mechanism actuator may, for example, comprise a lever or a button. The release mechanism actuator may be disposed on the head restraint. The release mechanism may be operated in conjunction with a height locking mechanism for adjusting the height of the head restraint.

Alternatively, or in addition, the release mechanism actuator may be disposed on the seatback of the vehicle seat. For example, a lever or a button may be disposed on the seatback to release the locking mechanism. The release mechanism may be operated in conjunction with a pivot release mechanism for pivoting the seatback.

A release cable may be provided for operating the release mechanism. The release cable may be disposed in the first mounting stem. Alternatively, the release cable may be disposed in a second mounting stem.

According to a further aspect of the present invention there is provided a seat assembly comprising a seatback, a lower seat portion and a head restraint as described herein. The actuating cable may be attached to a second anchor point disposed on the seatback or the lower seat portion.

The second anchor point may be fixed. Alternatively, the position of the anchor point may be adjustable to enable remote control of the pivoting of the head support. Alternatively, or in addition, may comprise a cable adjustment mechanism operable to adjust an effective length of the actuator cable to enable remote control of the pivoting of the head support. A lever or rotary member may adjust the effective length of the actuator cable. The lever may comprise an over-centre lever, for example.

The height (vertical position) of the head support may be adjustable relative to the seatback. The actuating cable may be operable to pivot the head support in dependence on the height of the head support. The actuating cable may couple the pivoting movement of the head support with adjustments in the height of the head support. This may facilitate configuring the head support to the usable position.

The height adjustment of the head restraint may be performed manually. A user may raise and/or lower the head support relative to the seatback. Alternatively, or in addition, a height control actuator may be provided to adjust the height of the head support. The height control actuator may, for example, comprise one of the following: a piston, a rack and pinion drive, and a linear actuator.

The seatback may be pivotable relative to the lower seat portion. The actuating cable may be operable to pivot the head support in dependence on a pivot angle of the seatback relative to the lower seat portion. The actuating cable may couple the pivoting movement of the head support with adjustments in the pivot angle of the seatback. This may facilitate configuring the head support to the usable position.

A pivot control member may be providing for controlling pivoting of the head restraint. The pivot control member may inhibit pivoting of the head restraint relative to the seatback. The pivot control member may function as a stop to inhibit or limit pivoting movement of the head restraint. The pivot control member may impede pivoting movement of the head restraint from the usable position to the unusable position and/or from the unusable position to the usable position. In use, the pivot control member may inhibit pivoting movement of the head restraint from the unusable position to the usable position when the head restraint is in a lowered position relative to the seatback. The head restraint may be retained in the unusable position when in the lowered position. When the head restraint is in the lowered position, the head restraint may engage the pivot control member to limit or inhibit pivoting movement of the head restraint. When the head restraint is in a raised position, the head restraint may pivot without engaging the pivot control member, thereby enabling a pivoting movement of the head restraint relative to the seatback.

According to a further aspect of the present invention there is provided a seat assembly comprising a seatback, a lower seat portion and a head restraint as described herein. The seat assembly may comprise a pivot control actuator for actuating the actuating cable to control pivoting of the head support about the pivot axis.

According to another aspect of the present invention, there is provided a seat assembly comprising a seatback, a lower seat portion and a head restraint, the head restraint comprising:
a head support;
a head restraint mounting assembly for mounting the head restraint to the seatback, the head restraint mounting assembly comprising a first mounting stem, wherein the head support is pivotably mounted to the head restraint mounting assembly; and
an actuating cable configured to control pivoting of the head support about a pivot axis,
wherein the pivot axis is disposed proximal to an end of the head support which is disposed adjacent to the seatback,
wherein the actuating cable is attached to the head support at a first anchor point which is offset vertically from the pivot axis and is attached to a second anchor point disposed on the seatback or the lower seat portion.

The height of the head restraint may be adjustable relative to the seatback, the actuating cable being operable to pivot the head support in dependence on the height of the head restraint.

The height of the head restraint may be adjustable relative to the seatback by relative movement of the first mounting stem with respect to the seat back, wherein the actuating cable is operable to pivot the head support in dependence on the height of the head restraint, wherein pivoting of the head support with respect to the first mounting stem toward a deployed position is independent of relative movement between the seatback and the lower seat portion.

The head restraint may comprise a pivot locking mechanism operable to inhibit or restrict pivoting movement of the head support about the pivot axis, wherein the pivot locking mechanism is operable to lock the head support in a predetermined orientation relative to the head restraint mounting assembly, wherein the predetermined orientation corresponds to the deployed position of the head support.

The head restraint may comprise a height locking mechanism configured to engage with the first mounting stem so as to secure the head support at a predetermined height, wherein the actuating cable is operable to pivot the head support to the predetermined orientation such that it is locked by the pivot locking mechanism in the deployed position when the head support is at the predetermined height.

The head restraint may comprise a release mechanism for releasing the locking mechanism. The head restraint may comprise a spring member for biasing the head support in a first pivot direction away from the deployed position and towards an unusable position.

The head restraint may comprise a pivot control member configured to limit or inhibit pivoting of the head support from the unusable position toward the deployed position when the head support is in a lowered position relative to the seatback.

According to a further aspect of the present invention there is provided a vehicle comprising a head restraint as described herein.

According to a further aspect of the present invention there is provided a vehicle comprising a seat assembly as described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic representation of a vehicle comprising a seat assembly having a head restraint in accordance with an embodiment of the present invention;

FIG. 2 illustrates the head restraint according to the present embodiment in first and second pivot positions;

FIG. 3A shows the seat assembly in an upright configuration with the head restraint in a usable position;

FIG. 3B shows the seat assembly in an upright configuration with the head restraint in the unusable position;

FIG. 3C shows the seat assembly in a stowed configuration with the head restraint pivoted to an unusable position;

FIG. 4 shows a mounting assembly of the head restraint according to the present embodiment;

FIG. 5A shows a schematic representation of the seat assembly in the stowed configuration;

FIG. 5B shows a schematic representation of the seat assembly in an upright configuration;

FIG. 5C shows a schematic representation of the head support in a first intermediate position between the unusable position and a usable position;

FIG. 5D shows a schematic representation of the head support in a second intermediate position between the unusable position and the usable position;

FIG. 5E shows a schematic representation of the head support in the usable position;

FIG. 6A shows a schematic representation of the head support release from the usable position;

FIG. 6B shows a schematic representation of the seat assembly folding towards the stowed configuration;

FIG. 6C shows a schematic representation of the seat assembly in the stowed configuration;

FIG. 7 shows a schematic representation of the seatback and head restraint configured for assembly;

FIGS. 8A, 8B and 8C illustrate the engagement of a head restraint operation when the head restraint is in a lowered position; and

FIG. 9 illustrates the pivoting movement of the head restraint to the usable position as it is raised.

### DETAILED DESCRIPTION

A vehicle seat 1 comprising a head restraint 2 (also known as a headrest) in accordance with an embodiment of the present invention is described herein with reference to the accompanying Figures. The vehicle seat 1 is suitable for a vehicle 3, such as an automobile. The vehicle 3 is described herein with reference to a reference frame comprising a longitudinal axis X, a transverse axis Y and a vertical axis Z.

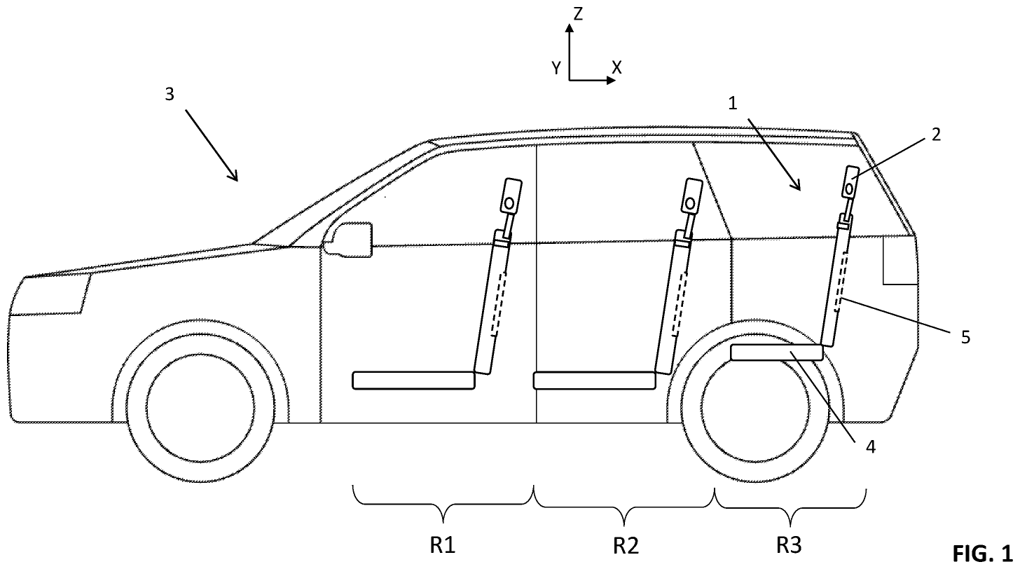

As shown in FIG. 1, the vehicle 3 comprises first, second and third rows R1-3 of seats. The vehicle seat 1 in the present embodiment is disposed in the third row R3 in the vehicle 3. The vehicle seat 1 is an occasional seat which may be stowed when not in use. The vehicle seat 1 comprises a lower seat portion (seat cushion) 4 and a seatback 5. The seatback 5 is pivotably mounted to the lower seat portion 4 and can pivot between a stowed position and an upright position. The head restraint 2 is mounted to the seatback 5. The head restraint 2 comprises a head support 7 for supporting a head of a seat occupant. The head support 7 comprises a support member 8. The support member 8 in the present embodiment is in the form of a rigid member, for example moulded from a plastic material. A cushion or padded member 9 is typically provided on a front face of the support member for improved occupant comfort. Alternatively, or in addition, the head restraint 2 may be disposed in a vehicle seat 1 in the second row R2 of the vehicle 3. The third row R3 of the vehicle seats 1 may be omitted from the vehicle 3.

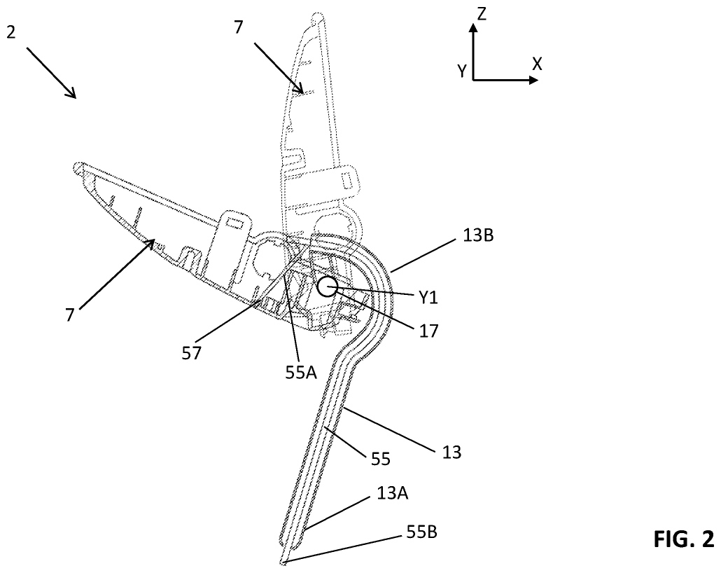

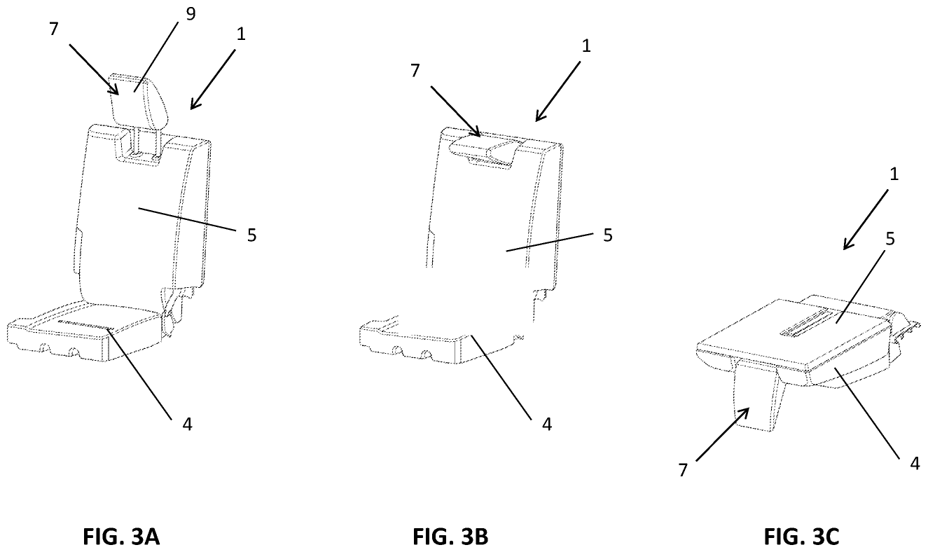

The head restraint 2 can be raised and lowered relative to the seatback 5. In use, the head restraint 2 is secured in a raised position. As illustrated in FIG. 2, the head support 7 is also pivotable about a pivot axis Y1 extending in a transverse direction. The head restraint 2 is configured to pivot the head support 7 between a usable position and an unusable position. The head support 7 is disposed in a car forward angular position of at least 60° (measured from the vertical axis Z) in the unusable position. The head support 7 may be disposed in a car forward angular position of between 60° and 90° (measured from the vertical axis Z) in the unusable position. In the present embodiment, the head support 7 is disposed in a car forward angular position of approximately 65° (measured from the vertical axis Z). The head support 7 in the unusable position is represented in FIG. 2; and the head support 7 in the usable position is represented in phantom in FIG. 2. In the present embodiment, the head support 7 is self-orienting. In particular, the head support 7 is configured to pivot in dependence on changes in the vertical position of the head restraint 2 relative to the seatback 5. The vertical displacement of the head restraint 2 causes a pivoting movement of the head support 7 relative to the seatback 5. The head support 7 is shown in the usable position in FIG. 3A; and in the unusable position in FIG. 3B. The vehicle seat 1 is shown in a stowed configuration in FIG. 3C with the head support 7 in the unusable position. The head support 7 is shown in the usable position in FIG. 3A; and in the unusable position in FIG. 3B. The vehicle seat 1 is shown in a stowed configuration in FIG. 3C with the head support 7 in the unusable position.

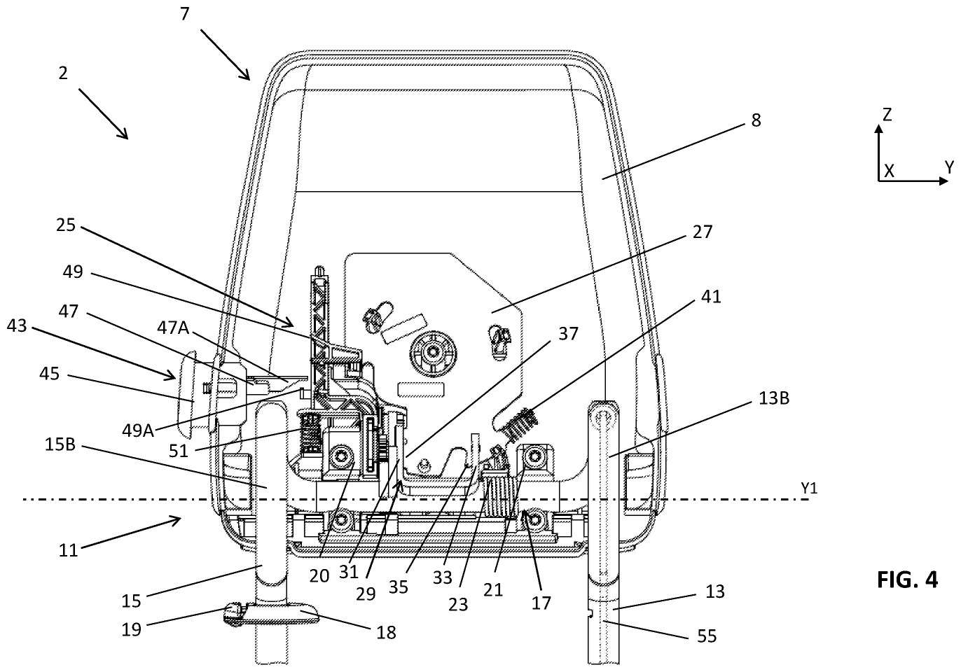

As shown in FIG. 4, the head restraint 2 comprises a head restraint mounting assembly 11 for mounting the head restraint 2 to the seatback 5. The head restraint mounting assembly 11 is configured pivotably to support the head support 7. In the usable position, the head support 7 is disposed in a generally upright position for supporting the head of the seat occupant. The vehicle seat 1 is suitable for use by an occupant when the head support 7 is in the usable position. Conversely, the vehicle seat 1 is rendered unsuitable for use by an occupant when the head support 7 is in the unusable position. In the unusable position, the head support 7 is pivoted forwards and is no longer suitable for supporting the head of the seat occupant.

The head restraint mounting assembly 11 comprises a first mounting stem 13, a second mounting stem 15 and a crossmember 17. The head support 7 is pivotably mounted to the crossmember 17. The crossmember 17 extends in a transverse direction. A longitudinal central axis of the crossmember 17 is coincident which the pivot axis Y1 of the head support 7. In the present embodiment, the first mounting stem 13, the second mounting stem 15 and the crossmember 17 are formed integrally. The first mounting stem 13, the second mounting stem 15 and the crossmember 17 are tubular and are formed integrally from a continuous tubular member. The first mounting stem 13 comprises a first lower section 13A; and a first upper section 13B. The second mounting stem 15 comprises a second lower section (not shown); and a second upper section 15B. The first and second lower sections 13A are configured to mount the first and second stems 13, 15 to the seat back 5. The first and second lower sections 13A extend substantially parallel to each other and are arranged to locate in respective first and second mounting tubes (not shown) disposed in the seatback 5. A height locking mechanism 18 is provided for engaging at least one of the first and second stems 13, 15 to retain the head support 7 at a predetermined height. The height locking mechanism 18 comprises at least one locking member (not shown) configured to engage one or more feature formed on the first mounting stem 13 and/or the second mounting stem 15. The height locking mechanism 18 is engaged when the head support 7 is at the predetermined height. A release mechanism 19 is provided for releasing the height locking mechanism 18.

The first and second upper sections 13B, 15B each have a curved profiled (generally C-shaped in the present embodiment) to accommodate pivoting movement of the head support 7. The head support 7 comprises first and second mounting brackets 20, 21 fixedly mounted to the support member 8. The first and second mounting brackets 20, 21 are configured pivotably to mount the head support 7 to the crossmember 17. The first and second mounting brackets 20, 21 enable the head support 7 to pivot about the pivot axis Y1. The first and second mounting brackets 20, 21 may each comprise a bearing assembly to facilitate rotational movement about the pivot axis Y1. It will be understood that other mounting arrangements may be used pivotably to mount the head support 7. For example, at least one pivot pin may be provided pivotably to mount the head support 7. The at least one pivot pin may be disposed on the crossmember 17. Alternatively, or in addition, the at least one pivot pin may be mounted to the first and second stems 13, 15, for example to the first and second upper sections 13B, 15B. A torsion spring 23 is provided for biasing the head support 7 towards the unusable position. The torsion spring 23 comprises a first end and a second end. The first end is connected to the crossmember 17 and the second end is connected to the head support 7.

As shown in FIG. 4, a pivot locking mechanism 25 is provided for retaining the head support 7 in the usable position. The pivot locking mechanism 25 is actuated when the head support 7 is pivoted to the usable position, thereby automatically locking the head support 7 in the usable position. The pivot locking mechanism 25 comprises a locking plate 27 operable selectively to engage a fixing member 29 mounted to the crossmember 17. The fixing member 29 comprises first and second upright members 31, 33. The first and second upright members 31, 33 comprises first and second apertures (not shown) for receiving first and second projections 35, 37 formed in the locking plate 27. The locking plate 27 is pivotably mounted to a pivot member and is moveable between a locked position and an unlocked position. A spring member 41 is provided for biasing the locking plate 27 towards the locked position. A release mechanism 43 is provided for releasing the locking plate 27. The release mechanism 43 comprises a release button 45, a trigger pin 47 and a trigger 49. The release button 45 is operable to displace the trigger pin 47 in an axial direction. The trigger pin 47 comprises an oblique surface 47A which operatively engages a cooperating surface 49A formed on the trigger 49. The displacement of the trigger pin 47 displaces the trigger 49 in an orthogonal direction (extending substantially vertical in the orientation shown in FIG. 4). A return spring 51 is provided to return the trigger 49 to an unactuated position. The trigger 49 is connected to the locking plate 27 and is operable to displace the locking plate 27 from the locked position to the unlocked position. Depressing the release button 45 causes the trigger pin 47 to actuate the trigger 49 and displace the locking plate 27 to the unlocked position. The pivot locking mechanism 25 is thereby unlocked by operating the release button 45 to enable the head support 7 to pivot away from the usable position, for example towards the unusable position.

A first actuating cable 55 is provided for actuating the head support 7. In particular, the first actuating cable 55 is provided to pivot the head support 7 about the pivot axis Y1. The first actuating cable 55 is configured to apply a pulling force to the head support 7. In the present embodiment, the first actuating cable 55 is configured to apply a pulling force to pivot the head support 7 from the unusable position to the usable position. The first actuating cable 55 is a flexible cable used to transmit mechanical force, for example comprising a spiral wound metal cable. The first actuating cable 55 may optionally be disposed in a sleeve (not shown). The first actuating cable 55 is fastened to the head support 7 at a location vertically offset from the pivot axis Y1. The first actuating cable 55 is disposed at least partially inside the first mounting stem 13. The curved profile of the first upper section 13B forms a guide for the first actuating cable 55. The first actuating cable 55 exits the first mounting stem 13 through an aperture 57 formed in the first upper section 13B. As shown in FIG. 2, a first end 55A of the first actuating cable 55 is fastened to the head support 7 at a first anchor point 57 which is vertically offset from the pivot axis Y1. In the present embodiment, a first mechanical fastener (not shown) is provided for fastening the first actuating cable 55 to the support member 8. The first anchor point 57 is disposed above the pivot axis Y1 (i.e., towards a top of the head support 7 in the arrangement illustrated in FIG. 4).

The actuation of the head support 7 is described herein with reference to the first actuating cable 55. Alternatively, or in addition, a second actuating cable (not shown) may be provided to apply a pulling force to pivot the head support 7 from the usable position to the unusable position. The second actuating cable could be provided in the first mounting stem 13 or the second mounting stem 15. The first actuating cable 55 may be provided along with the second actuating cable to provide a closed loop system for controlling pivoting of the head support 7 in each direction.

A second end 55B of the first actuating cable 55 is fastened to the seatback 5 at a second anchor point (not shown). For example, the second end 55B of the first actuating cable 55 may be fastened to a seat frame member. The second end 55B extends out of the lower end of the first actuating cable 55 and is fastened to the seatback 5. The second anchor point in the present embodiment is fixed. A second mechanical fastener is provided for fastening the first actuating cable 55 to the seatback 5. The length of the first actuating cable 55 is at least substantially fixed. The displacement of the head support 7 upwardly causes the first actuating cable 55 to apply a pulling force to the head support 7. The resulting pulling force causes the head support 7 to pivot about the pivot axis Y1. In particular, the pulling force causes the head support 7 to pivot from the unusable position to the usable position as the head support 7 is displaced upwardly. The pivot locking mechanism 25 is operable to lock the head support 7 in the usable position. The head support 7 is thereby retained in the usable position. The height locking mechanism 18 is operable to secure the vertical height of the head restraint 2.

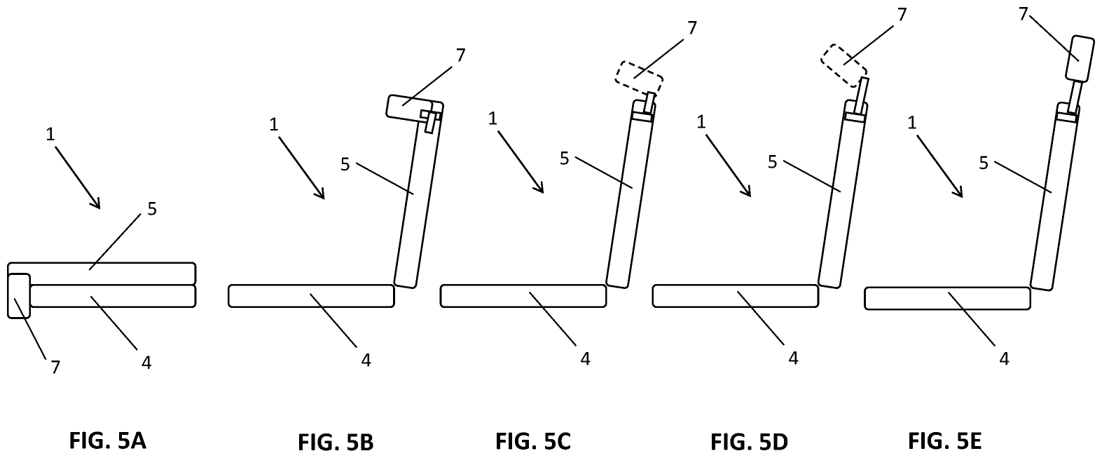

The reconfiguration of the vehicle seat 1 and the head restraint 2 from a stowed configuration to a usable configuration will now be described with reference to FIGS. 5A-5E. The vehicle seat 1 is shown in FIG. 5A with the seatback 5 in a stowed position against the lower seat portion 4. The head support 7 is pivoted forwards relative to the seat back 5 in the unusable position. To re-conFIG. the vehicle seat 1, the seat back 5 is pivoted to an upright position. The torsion spring 23 biases the head support 7 towards the unusable position. As shown in FIG. 5B, the head support 7 remains in the unusable position as the seat back 5 is pivoted upwardly. The user then lifts the head restraint 2 at the base relative to the seat back 5. The lifting of the head restraint 2 increases the tension in the first actuating cable 55 which applies a pulling force to the head support 7. The pulling force applied by the first actuating cable 55 is sufficient to overcome the biasing force generated by the torsion spring 23 and the head support 7 begins to pivot from the unusable position towards the usable position, as shown in FIG. 5C. If the user releases the head restraint 2, the head restraint 2 drops relative to the seatback 5. Moreover, the torsion spring 23 biases the head support 7 towards the unusable position. The head support 7 will be biased towards the unusable position if not locked in position. As shown in FIG. 5D, the user continues to lift the head support 7 which causes further pivoting of the head support 7 towards the usable position. When the head support 7 is displaced upwardly to the predetermined height, the height locking mechanism 18 engages the first mounting stem 13 and/or the second mounting stem 15 to secure the vertical position of the head support 7. The first actuating cable 55 is configured such that the head support 7 is pivoted to the usable position when the head support 7 is disposed at the predetermined height. The pivot locking mechanism 25 operates to retain the head support in the usable position, as shown in FIG. 5E. The first actuating cable 55 is not required to be load bearing under rear load test case as the locking plate 27 is load bearing.

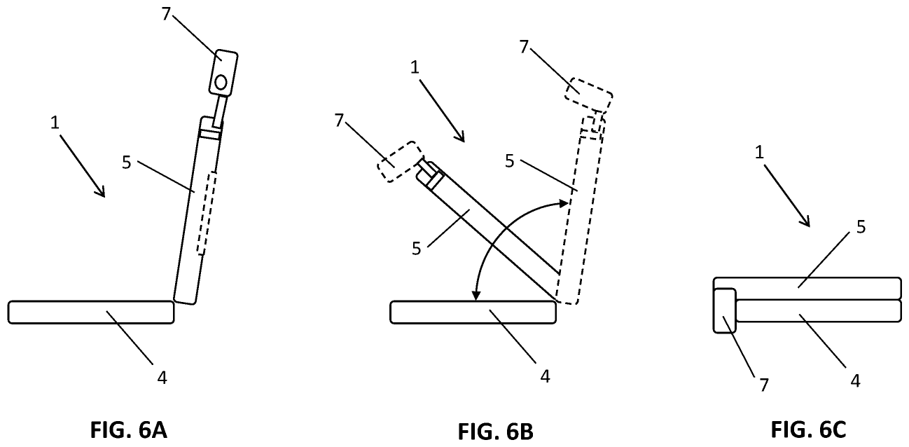

The reconfiguration of the vehicle seat 1 and the head restraint 2 from the usable configuration to a stowed configuration will now be described with reference to FIGS. 6A-6C. In order to release the head restraint 3 from the usable position, the user depresses the release button 45 to release the pivot locking mechanism 25. The locking plate 27 disengages and the head support 7 pivots forwards slightly under the action of the torsion spring 23. The user may then operate a seatback release mechanism to enable the seatback 5 to pivot relative to the lower seat portion 4. The user also disengages the height locking mechanism 19, as shown in FIG. 6A. The height locking mechanism 19 releases the first and second stems 13, 15 and the head support 7 pivots forwards and travels downwardly, as illustrated by the broken line representation of the seat back 5 shown in FIG. 6B. The user pivots the seatback 5 forwards towards the lower seat portion 4, as illustrated by the continuous line representation of the seat back 5 shown in FIG. 6B. The head support 7 is biased towards the unusable position by the torsion spring 23. The vehicle seat 2 is thereby returned to the stowed configuration, as shown in FIG. 6C. By pivoting the head support 7 to the unusable position, stowage of the vehicle seat 2 is facilitated. In the stowed configuration, the seatback 5 may form a flat floor, for example of a load bay.

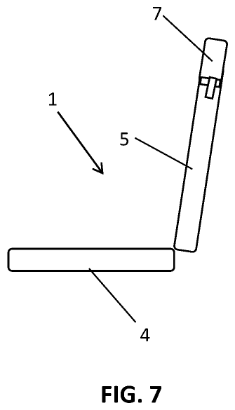

To assemble the vehicle seat 2, the head support 7 is disposed in a vertical (usable) position with the head restraint 1 in the lowest position, as illustrated in FIG. 7. This configuration allows the first actuating cable 55 to be attached to the seatback 5. This seating condition is only available during assembly.

The release button 45 for releasing the unpivot locking mechanism 25 is illustrated as being located on a side of the head support 7 in the present embodiment. Other mounting locations for the release button 45 are contemplated. Alternatively, or in addition, the pivot locking mechanism 25 could comprise a remote release mechanism. The remote release mechanism could comprise a release cable for unlocking the pivot locking mechanism 25. By way of example, the release cable could be configured to actuate one or more of: the trigger pin 47, the trigger 49 and the locking plate 27. The release cable could be connected to a release mechanism, such as a lever, a button or a rotary knob. The release mechanism may be positioned distal from the head restraint 2. The release mechanism could, for example, be disposed on the seatback 5 or the seat squab 6. The actuating mechanism could be provided on a back of the seatback 5.

The first actuating cable 55 has been described as being fastened to the seatback 5 at a second anchor point. In a variant, a pivot control actuator may be provided for controlling the pulling force applied by the actuating cable. The pivot control actuator may, for example, comprise a lever or rotary knob operable to adjust the effective length of the first actuating cable 55. The pivot control actuator may be operated to control pivoting of the head support 7 about the pivot axis Y1. The pivot control actuator could be provided on the seat back 5. The pivot control actuator may be coupled to the seatback release mechanism operable to pivot the seatback 5. A single actuator may control both pivoting movement of the seatback and the pivoting of the head support 7.

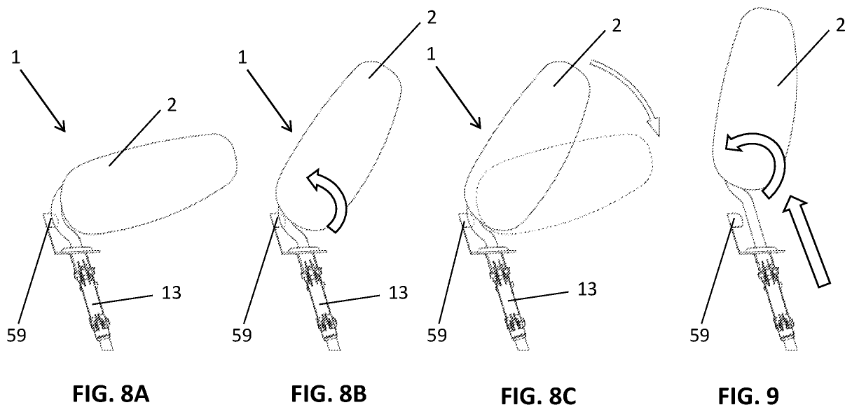

As shown in FIGS. 8A to 8D, a pivot control member 59 may be provided for controlling pivoting of the head restraint 2. The pivot control member 59 may, for example, inhibit pivoting of the head restraint 2 relative to the seatback 5. The pivot control member 59 may function as a stop to inhibit or limit pivoting movement of the head restraint 2. The pivot control member 59 may impede pivoting movement of the head restraint 2 from the usable position to the unusable position and/or from the unusable position to the usable position. For example, the pivot control member 59 may be configured to inhibit pivoting movement of the head restraint 2 from the unusable position to the usable position when the head restraint 2 is in a lowered position relative to the seatback 5. Thus, the head restraint 2 may be retained in the unusable position when in the lowered position.

The head restraint 2 is shown in an unusable position in FIG. 8A. When the head restraint 2 is in a lowered position (relative to the seatback 5), the head restraint 2 engages the pivot control member 59 to limit or inhibit pivoting movement of the head restraint 2 relative to the seatback 5. As shown in FIG. 8B, when the head restraint 2 is pivoted upwardly, the pivot control member 59 is engaged. The pivot control member 59 limits pivoting motion of the head restraint 2, to approximately 40° in the present embodiment. The pivot control member 59 prevents the head restraint 2 from locking in the usable position when pivoted in the lowered position. As shown in FIG. 8C, the head restraint 2 falls back towards the unusable position. As shown in FIG. 9, when the head restraint 2 is raised (relative to the seatback 5), the head restraint 2 is pivotable without engaging the pivot control member 59. The first actuating cable 55 causes the head restraint 2 to pivot to the usable position as it is raised. The head restraint 2 is raised (relative to the seatback 5) and is free to pivot past the pivot control member 59. The head restraint 2 is locked in the usable position, as described herein. The pivot control member may be disposed on the seatback 5. The pivot control member may, for example, be configured to engage the support member 8 or the crossmember 17 of the head restraint 2.

It will be appreciated that various changes and modifications can be made to the present invention without departing from the scope of the present application.

1. A head restraint for a vehicle seat having a seatback, the head restraint comprising:
a head support;
a head restraint mounting assembly for mounting the head restraint to the seatback, the head restraint mounting assembly comprising a first mounting stem, wherein the head support is pivotably mounted to the head restraint mounting assembly; and
an actuating cable configured to control pivoting of the head support about a pivot axis.

2. The head restraint as claimed in claim 1, wherein the actuating cable is fastened to the head support at a first anchor point which is offset vertically from the pivot axis.

3. The head restraint as claimed in claim 1, wherein the head restraint mounting assembly comprises a crossmember which defines the pivot axis.

4. The head restraint as claimed in claim 1 comprising a spring member for biasing the head support towards an unusable position.

5. The head restraint as claimed in claim 1, wherein the actuating cable is disposed at least partially inside the first mounting stem.

6. The head restraint as claimed in claim 1 comprising a pivot locking mechanism operable to inhibit or restrict pivoting movement of the head support about the pivot axis.

7. The head restraint as claimed in claim 6, wherein the pivot locking mechanism is operable to lock the head support in a predetermined orientation relative to the head restraint mounting assembly, wherein a release mechanism is provided for releasing the pivot locking mechanism.

8. A seat assembly comprising a seatback, a lower seat portion and the head restraint as claimed in claim 1, wherein the actuating cable is attached to a second anchor point disposed on the seatback or the lower seat portion.

9. The seat assembly as claimed in claim 8, wherein a height of the head restraint is adjustable relative to the seatback, the actuating cable being operable to pivot the head support based at least in part on the height of the head restraint.

10. The seat assembly as claimed in claim 8, wherein the seatback is pivotable relative to the lower seat portion, the actuating cable being operable to pivot the head support based at least in part on a pivot angle of the seatback relative to the lower seat portion.

11. A seat assembly comprising a seatback, a lower seat portion and the head restraint as claimed in claim 1, wherein the seat assembly comprises a pivot control actuator for actuating the actuating cable to control pivoting of the head support about the pivot axis.

12. A vehicle comprising the seat assembly according to claim 8.

13. A seat assembly comprising a seatback, a lower seat portion and a head restraint, the head restraint comprising:
a head support;
a head restraint mounting assembly for mounting the head restraint to the seatback, the head restraint mounting assembly comprising a first mounting stem, wherein the head support is pivotably mounted to the head restraint mounting assembly; and
an actuating cable configured to control pivoting of the head support about a pivot axis,
wherein the pivot axis is disposed proximal to an end of the head support which is disposed adjacent to the seatback,
wherein the actuating cable is attached to the head support at a first anchor point which is offset vertically from the pivot axis and is attached to a second anchor point disposed on the seatback or the lower seat portion.

14. The seat assembly as claimed in claim 13, wherein a height of the head restraint is adjustable relative to the seatback, the actuating cable being operable to pivot the head support based at least in part on the height of the head restraint.

15. The seat assembly as claimed in claim 13, wherein a height of the head restraint is adjustable relative to the seatback by relative movement of the first mounting stem with respect to the seatback, wherein the actuating cable is operable to pivot the head support based at least in part on the height of the head restraint, wherein pivoting of the head support with respect to the first mounting stem toward a deployed position is independent of relative movement between the seatback and the lower seat portion.

16. The seat assembly as claimed in claim 15, wherein the head restraint comprises a pivot locking mechanism operable to inhibit or restrict pivoting movement of the head support about the pivot axis, wherein the pivot locking mechanism is operable to lock the head support in a predetermined orientation relative to the head restraint mounting assembly, wherein the predetermined orientation corresponds to the deployed position of the head support.

17. The seat assembly as claimed in claim 16, wherein the head restraint comprises a height locking mechanism configured to engage with the first mounting stem so as to secure the head support at a predetermined height, wherein the actuating cable is operable to pivot the head support to the predetermined orientation such that it is locked by the pivot locking mechanism in the deployed position when the head support is at the predetermined height.

18. The seat assembly as claimed in claim 17, wherein the head restraint comprises a release mechanism for releasing the pivot locking mechanism, and wherein the head restraint comprises a spring member for biasing the head support in a first pivot direction away from the deployed position and towards an unusable position.

19. The seat assembly as claimed in claim 18, wherein the head restraint comprises a pivot control member configured to limit or inhibit pivoting of the head support from the unusable position toward the deployed position when the head support is in a lowered position relative to the seatback.

20. A vehicle comprising the seat assembly as claimed in claim 13.
